(19) United States
(12) Patent Application Publication
(10) Pub. No.: US 2019/0133371 A1
(43) Pub. Date: May 9, 2019

(54) Baking Pan

(71) Applicant: Joseph Bavuso, JR., Evergreen, CO (US)

(72) Inventor: Joseph Bavuso, JR., Evergreen, CO (US)

(21) Appl. No.: 16/174,855

(22) Filed: Oct. 30, 2018

Related U.S. Application Data
(60) Provisional application No. 62/582,707, filed on Nov. 7, 2017.

(51) Int. Cl. A47J 37/01

(52) U.S. Cl. CPC A47J 37/01

(57) ABSTRACT

A baking pan is disclosed which protects edges of baked goods from becoming hard, chewy, burned, or caramelized during baking. An example baking pan may include a first sidewall forming an outer perimeter of a bottom surface, and a second sidewall forming an inner perimeter within the first sidewall, the inner perimeter defining a baking area for a product being baked. An insulating gap is formed between the first sidewall and the second sidewall, thereby providing an even baking temperature for both edges of the product being baked and a middle portion of the product being baked. A removable lid at least partly covers the insulating gap and overlaps the baking area to protect edges of the product being baked from direct heat from above.

### CROSS REFERENCE TO RELATED APPLICATIONS

This application claims the priority benefit of U.S. Provisional Patent Application No. 62/582,707 filed Nov. 7, 2017 for “Baking Pan,” hereby incorporated by reference in its entirety as though fully set forth herein.

### BACKGROUND

Baking foods in a pan normally produces edges to the baked goods that are different in texture and flavor from the rest of the baked material. There are two suggested solutions to properly bake pan goods without altered edges, or with more desirable edges. The first suggestion is to alter the recipe. This is not an effective solution as recipes are made to be followed, and changing a recipe does not provide the same end result. The second suggestion is to line the pan with parchment paper before adding the ingredients. However, the primary use of parchment paper is to prevent ingredients from sticking to the pan, and therefore does not always work for preventing hard, chewy, burned, or caramelized edges.

### BRIEF DESCRIPTION OF THE DRAWINGS

FIG. 1A is a top view of an example baking pan with gap formed around an outer edge.

FIG. 1B is an isometric view of the example baking pan.

FIG. 2 is a side cross-sectional view of the example baking pan.

FIG. 3 is a top isometric view of the example baking pan with an example edge lid.

FIG. 4 is a top isometric view of the example baking pan with the example lid removed and shown separately.

FIG. 5 is another top isometric view of the example baking pan with two outer edges of the lid shown aligned with two outer edges of the baking pan to show an interior overlap that the lid provides.

### DETAILED DESCRIPTION

A baking pan is disclosed as it may have gap formed around an outer edge of the pan to provide an edge of the baked good (e.g., a brownie or cake) that is more consistent with the inner portion of the baked good. That is, the baking pan enables baking without the hard, chewy, burned, or caramelized edges. The gap formed around the edge of the example baking pan shields the outside edges and top edges from excess heat, in order to provide a more uniform consistency for the finished baked product. The example baking pan with air gap edge can be implemented for a wide variety of baked products including but not limited to brownies, cakes, bar cookies, quick breads, shortbreads, and even meals (e.g., lasagna). In other words, any product that is baked in a traditional pan can be baked in the baking pan disclosed herein.

The baking pan disclosed herein may be referred to as an “edgeless” baking pan. That is, the baking pan can be considered to be “edgeless” because the gas provided between the baked good and the outer edge of the baking pan reduces or altogether eliminates heat-related changes to edge of the baked product by moving the edge of the baked product away from the outermost edge of the baking pan, providing a barrier (e.g., an air gap) between the outermost edge of the baking pan and the innermost edge of the baking pan (and hence the product being baked). As such, the baking pan produces a consistency for the edge pieces of baked goods that more closely resembles a “middle” piece of the baked good. That is, the edge pieces of the baked goods resembles in quality and texture, a piece of the baked good that is taken or cut from within the baked good, of which no part was directly adjacent to the pan edge during baking. This uniform, consistent outcome across the entirety of the baked good (including the edges of the baked good) is achieved by shielding the outside edges and top edges from excess heat.

In an example, heat during baking is shielded from the edge by way of the gap formed around the perimeter of the baking pan. This gap can be empty (e.g., having only air) or can be filled with any other substance (e.g., an insulator, water, etc.). In another example, the baking pan may also include a gap between the inside bottom of the pan (i.e., the surface adjacent the baked product) and the outside bottom of the pan (i.e., the outer surface that sits on the oven rack).

In an example, the baking pan may be configured as a single pan formed with two perimeter walls (e.g., a double perimeter wall), an outer perimeter wall (or “edge”) and an inner perimeter wall (or “edge”). In another example, the baking pan may be configured as a separate smaller pan formed within a larger pan. In this example, the “two pans” may be connected or formed together, or may be separable (e.g., to enhance cleaning).

In either case, the dual wall configuration forms a “gap” between the outer pan and the inner “baking surface” of the pan, creating an insulating gap which delays or lowers the transfer of heat to the inside of the pan directly adjacent the baking product. This insulating gap substantially decouples the outside of the baking pan (which is subject to higher heat from the oven) from the inside of the baking pan (which is directly adjacent the product being baked).

In another example, the baking pan may also include a lid. In an example, the lid has a center opening to allow heat onto the top surface of the product being baked and only covers the outer edge of the pan. In an example, the lid substantially aligns with the outside edge of the pan, but overlaps the gap on the inside of the pan to cover from the top the outside perimeter or edge of the product being baked. This configuration of the lid provides additional protection from direct transfer of radiative and convective heat above the edges of the baked goods to also provide a more consistent baking of the edge and the center of the product being baked.

It is noted that the gap formed between the inside of the baking pan (directly adjacent the product being baked) and the outside of the baking pan (open to the oven) may provide insulation via the space or gap, which limits the direct transfer of heat through conduction and/or the convective transfer of heat within the air gap. The lid also protects against direct transfer of radiative and convective heat from above. These two features provide protection of the product being baked so that the finished baked product is substantially even and consistent throughout, such that the edge pieces more closely resemble the middle pieces in consistency, texture, and finish.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the baking pan described herein is only an example and not intended to be limiting. Other sizes and shapes of the baking pan may also be provided which include one or more characteristics of the example baking pan shown in the drawings and thus are also considered to be a part of the invention claimed herein.

It is further noted that the operations shown and described herein are provided to illustrate example implementations. It is noted that the elements and operations are not limited to the ordering shown. Still other elements and operations may also be implemented.

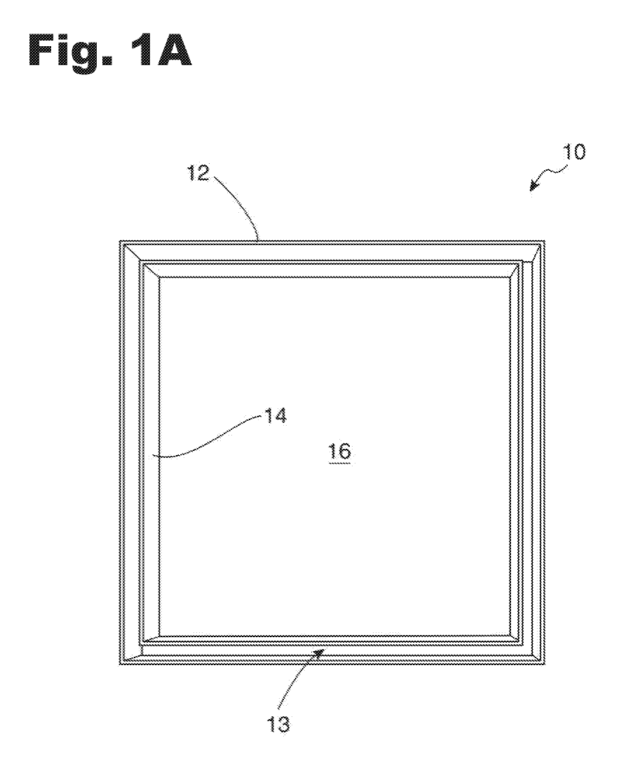

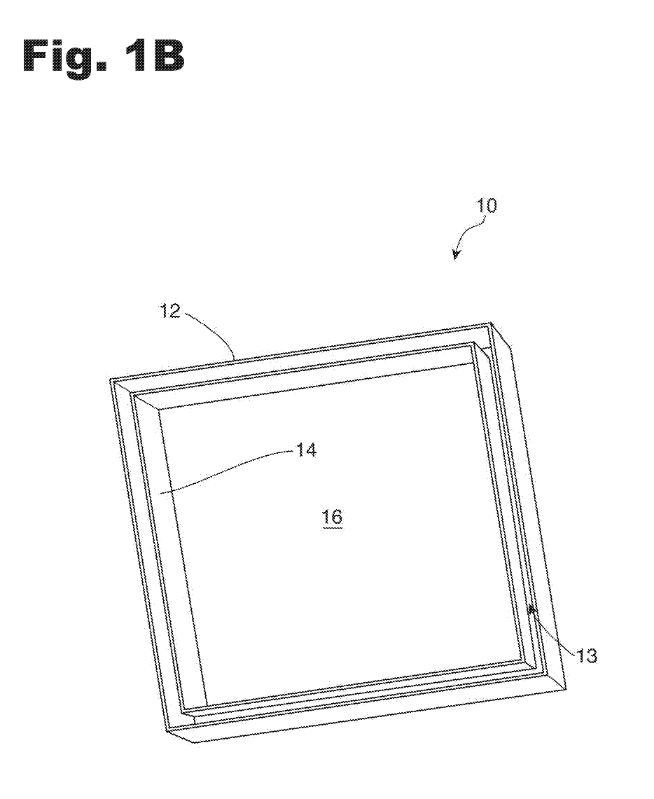

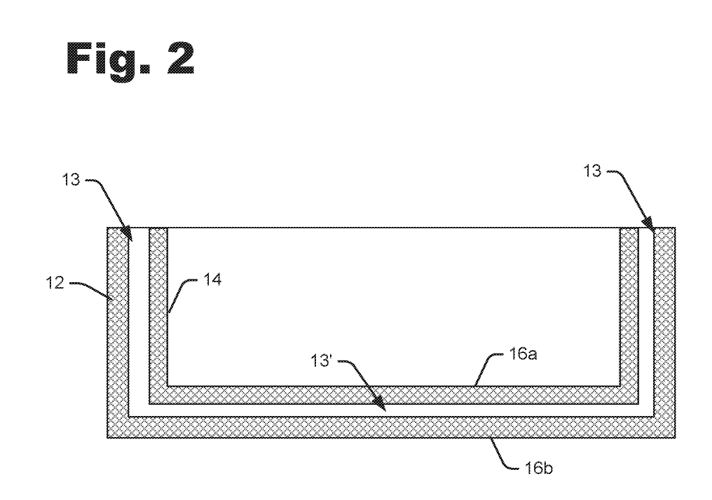

FIG. 1A is a top view of an example baking pan 10 with gap 13 formed around an outer edge. FIG. 1B is an isometric view of the example baking pan 10. FIG. 2 is a side cross-sectional view of the example baking pan 10.

The example baking pan 10 is shown as it may include a first or “outer” wall 12 forming an outer perimeter. The example baking pan 10 also includes a second or “inner” wall 14 forming an inside perimeter of the baking pan. The outer perimeter is directly in contact with heat from an oven or other heat source during baking. The inner perimeter is directly in contact with the product being baked and defines a baking area, In an example, the gap 13 is formed between the first wall 12 and the second wall 14. The gap 13 may be empty (e.g., an air gap) or may be filled with an insulating material, sealed to include an insulating liquid or gas, etc.

In an example, the baking pan 10 may be configured as a single pan having first wall 12 and second wall 14, and bottom surface 16. In an example, the bottom surface 16 may also have a gap 13′ (e.g., formed between an inner bottom surface 16a and an outer bottom surface 16b).

In another example, the baking pan 10 may have a separate pan (e.g., having edges 14) which sits inside of a larger outer pan (e.g., having edges 12). The inner pan may have a separate bottom, or may share the bottom 16 with the outer pan (e.g., the inner “pan” may just have perimeter walls without an attached bottom).

The cross-sectional view shown in FIG. 2 can be interpreted to illustrate either the integral configuration, or the “separate pan” configuration.

In an example, the gap 13 or distance provided between the first wall 12 and the second wall 14 (and gap 13′ between surfaces 16a and 16b) may be selected to delay the transfer of heat to allow the pan goods to bake consistently without overheating the outside edges. This distance may vary, depending on design considerations, such as the material the baking pan 10 is made of, the baking temperature, the desired end product, to name only a few examples.

It is noted that the baking pan 10 is referred to herein as an “edgeless” baking pan, not because the baking pan 10 itself does not have edges, but because the baked product does not have the traditional hard, chewy, burned, or caramelized edges. In other words, the gap of the baking pan 10 results in little if any heat-related changes to the edge of the baked good that may otherwise affect flavor, texture, and consistency of the baked good. The baking pan produces a consistent baked product which is typically associated with a middle piece of the baked good (e.g., without edges). After baking is complete, all of the pan goods (e.g., brownies) are soft throughout, and there are no hard or readily distinguishable edges.

In other examples, various size gaps and positions of gaps may be provided. In an example with a square pan, the corner presents a slightly larger insulating air gap than the edge does. This has not been shown to affect the taste, texture, or consistency of the corner pieces. However, a smaller size and/or shape gap may be provided at one or more of the corners of the baking pan. Other shapes and sizes of the baking pan 10 and/or components thereof may also be selected to adapt the baking pan for this and/or other desired characteristics of the baked product.

It should be noted that as a design choice, the walls of the inner pan 14 and outer pan 12 may also be held apart using standoffs 24, although this is not necessary and may result in somewhat greater heat transfer between the inner and outer pans.

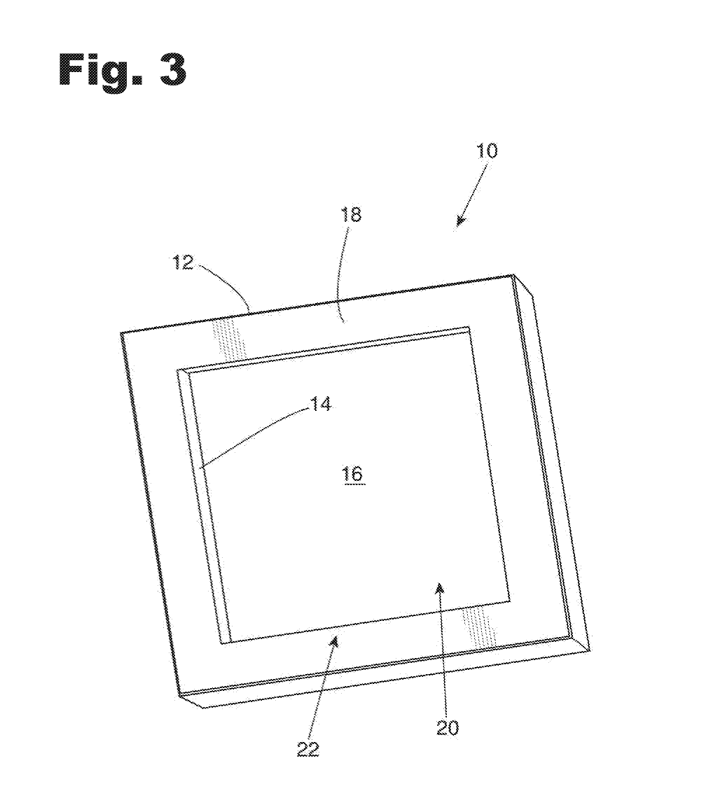

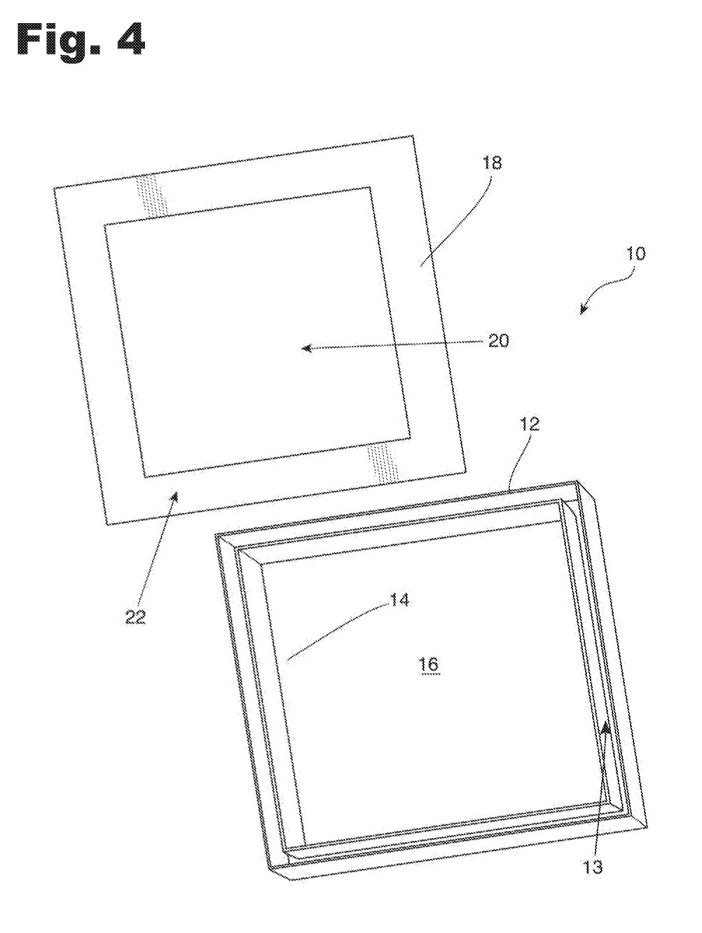

FIG. 3 is a top isometric view of the example baking pan 10 with an example edge lid 18. FIG. 4 is a top isometric view of the example baking pan 10 with the example lid 18 removed and shown separately.

In an example, the lid 18 is formed with a lid opening 20. The lid opening 20 permits heat to transfer in and out of the top of the baking pan 10 during baking. The lid 18 covers the gap 13 between the perimeter edges 12 and 14. As such, the lid 18 serves to keep heat out of the gap 13, thus providing the insulating function.

It is noted that the cover for the gap 13 may be permanently attached (e.g., so that the gap 13 is “sealed”), or removable, e.g., as shown in FIG. 4.

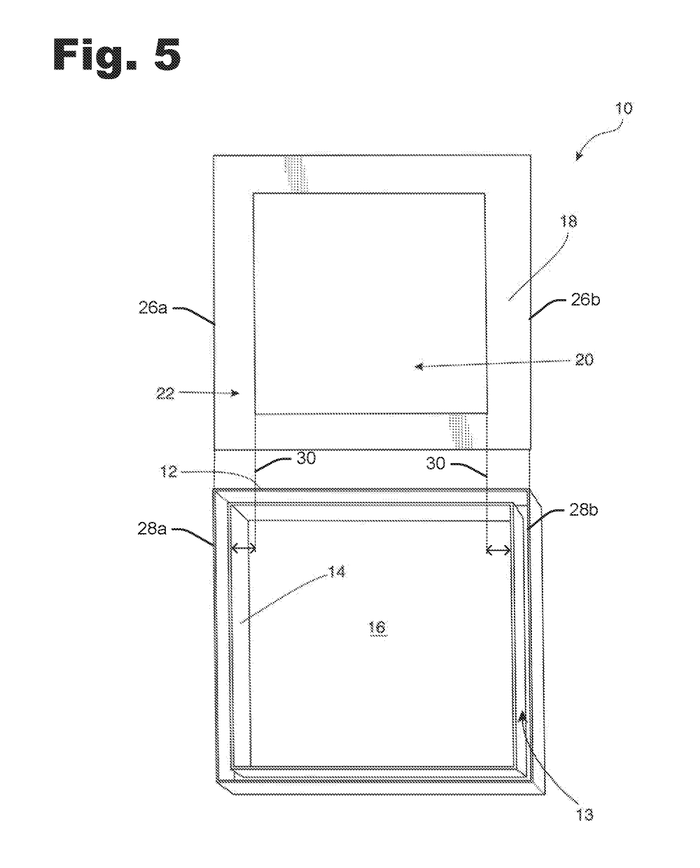

In an example, the lid 18 also has an inner lip 22. Lip 22 extends beyond the inside wall 14 to partially cover the product being baked (e.g., covering the edges of the baking product). The lip 22 can be seen in FIG. 5. FIG. 5 is another top isometric view of the example baking pan 10 with two outer edges 26a-b of the lid 18 shown aligned with two outer edges 28a-b of the baking pan 10 to show an interior overlap (illustrated by dashed lines 30) that the lid 18 provides over the second walls 14, and hence over the outer perimeter of the product being baked. It is noted that this lip 22 may be provided around one or more edges (e.g., all four edges in the example shown in FIG. 5). As such, the lip 22 further serves to protect the edges of the product being baked from direct heat coming from above.

It should be noted that the examples described above are provided for purposes of illustration, and are not intended to be limiting. Other devices and/or device configurations may be utilized to carry out the operations described herein.

By way of illustration, the baking pan can be produced with various materials, shapes, sizes, thicknesses, or depths that are optimized for the baking of different products such as brownies, pan cookies, quick breads, and shortbreads. The example baking pan may include, but is not limited to, one or more of handles, additional notches, grooves, pins, or parts to secure the lid to the inner, outer, or both pans, coatings, additional spacer or spacers which lift the inner pan away from the bottom surface of the outer pan to limit transfer of heat from underneath. In an example, these spacer(s) may be attached to the inner pan, outer pan, or floating, and may be made of the same or different materials than the pans themselves.

The pans may be permanently joined, separably joined, or entirely separate objects. The pans may be of a variety of different shapes, including but not limited to square, rectangular, triangular, circular, hexagonal, novelty shapes, etc. Standoffs may be formed in a wide variety of shapes, sizes, orientations, and distribution patterns. The pans may be configured to include multiple small pockets or baked goods areas, and a lid containing multiple apertures aligned with these pockets, for baking smaller goods including but not limited to cupcakes, muffins, and cookies. The air gap may be larger or smaller than shown herein, to reduce, increase, or fine-tune convection and other heat transfer modes. The pans may be made from conductive or non-conductive materials, and may include a mirror finish or other low-emissivity finish to reduce radiative heat transfer between inner and outer pans.

The pans may be made of flexible materials such as silicone, or rigid materials such as metal, ceramic, and rigid plastics, and may be of any color. Small holes, vents, or other apertures may be present to permit the escape of steam rather than its entrapment against the sides of the pan, while being of such size that surface tension prevents the leakage or expansion of ingredients outward through the apertures. The air gap may include rigid insulation materials such as metallic, ceramic, or polymeric foams or aerogels. None of the aforementioned variations depart from the spirit of the present disclosure or its intended purpose of reducing the edge heating and texture or composition changes to the edges of baked goods during the baking process.

It is noted that the examples shown and described are provided for purposes of illustration and are not intended to be limiting. Still other examples are also contemplated.

1. A baking pan, comprising:
a bottom surface;
a first sidewall forming an outer perimeter of the bottom surface;
a second sidewall forming an inner perimeter within the first sidewall, the inner perimeter defining a baking area for a product being baked; and
an insulating gap formed between the first sidewall and the second sidewall, the insulating gap providing a heat gradient during baking with a higher temperature toward the first sidewall and a lower temperature toward the second sidewall, thereby providing an even baking temperature for edges of the product being baked and a middle portion of the product being baked.

2. The baking pan of claim 1, wherein the first sidewall is substantially square, and the second sidewall is substantially square.

3. The baking pan of claim 1, wherein the insulating gap is substantially a square space formed around an edge of the baking area.

4. The baking pan of claim 1, further comprising an insulating gap formed between a first outside pan bottom and a second inside pan bottom.

5. The baking pan of claim 1, further comprising a lid.

6. The baking pan of claim 1, further comprising a lid having an outer surface defining an opening within the lid.

7. The baking pan of claim 6, further comprising an inner edge of the outer surface, the inner edge defining an outside boundary of the opening formed within the lid.

8. The baking pan of claim 7, wherein the lid overlaps baking area defined by the second sidewall to protect edges of the product being baked from direct heat from above.

9. The baking pan of claim 1, wherein the first sidewall is connected to the bottom surface, and the second sidewall is also connected to the bottom surface.

10. The baking pan of claim 1, wherein the second sidewall is removable from the bottom surface

11. The baking pan of claim 1, wherein the first sidewall is a first pan, and the second sidewall is a second pan, the first pan separable from the second pan.

12. The baking pan of claim 10, wherein the insulating gap is at least partly open.

13. The baking pan of claim 10, wherein the insulating gap is sealed.

14. A baking pan configured to produce edgeless baked goods, comprising:
at least one bottom surface;
a first sidewall forming an outer perimeter of the bottom surface;
a second sidewall forming an inner perimeter within the first sidewall, the inner perimeter defining a baking area for a product being baked;
an insulating gap formed between the first sidewall and the second sidewall, the insulating gap providing a heat gradient during baking with a higher temperature toward the first sidewall and a lower temperature toward the second sidewall, thereby providing an even baking temperature for edges of the product being baked and a middle portion of the product being baked; and
a removable lid to at least partly cover the insulating gap.

15. The baking pan of claim 14, wherein the first sidewall is substantially square, and the second sidewall is substantially square, and wherein the insulating gap is substantially a square space formed around an edge of the baking area.

16. The baking pan of claim 14, further comprising an insulating gap formed between a first outside pan bottom and a second inside pan bottom.

17. The baking pan of claim 14, wherein the lid overlaps the baking area defined by the second sidewall to protect edges of the product being baked from direct heat from above.

18. A baking pan configured to produce edgeless baked goods; comprising:
at least one bottom surface;
a first sidewall forming an outer perimeter of the bottom surface;
a second sidewall forming an inner perimeter within the first sidewall, the inner perimeter defining a baking area for a product being baked;
an insulating gap formed between the first sidewall and the second sidewall, the insulating gap providing a heat gradient during baking with a higher temperature toward the first sidewall and a lower temperature toward the second sidewall, thereby providing an even baking temperature for edges of the product being baked and a middle portion of the product being baked;
wherein the first sidewall is substantially square, and the second sidewall is substantially square, and wherein the insulating gap is substantially a square space formed around an edge of the baking area;
an insulating gap formed between a first outside pan bottom and a second inside pan bottom; and
a removable lid to at least partly cover the insulating gap, wherein the lid overlaps the baking area defined by the second sidewall to protect edges of the product being baked from direct heat from above.

19. The baking pan of claim 1, wherein the first sidewall is integrally formed as part of the bottom surface, and the second sidewall is also integrally formed as part of the bottom surface.

20. The baking pan of claim 1, wherein the first sidewall is a first pan, and the second sidewall is a second pan, the first pan separable from the second pan.
